(19) United States
(12) Patent Application Publication
(10) Pub. No.: US 2015/0097840 A1
(43) Pub. Date: Apr. 9, 2015

(54) VISUALIZATION METHOD, DISPLAY METHOD, DISPLAY DEVICE, AND RECORDING MEDIUM

(71) Applicant: FUJITSU LIMITED, Kawasaki-shi (JP)

(72) Inventors: Takehiko Nishimura, kawasaki (JP); Yuki Sato, Yokohama (JP)

(73) Assignee: FUJITSU LIMITED, Kawasaki (JP)

(21) Appl. No.: 14/471,338

(22) Filed: Aug. 28, 2014

(30) Foreign Application Priority Data
Oct. 4, 2013 (JP) 2013-209707

(51) Int. Cl. G06T 11/20; G06T 11/00

(52) U.S. Cl. CPC G06T 11/203; G06T 11/001
USPC 345/443

(57) ABSTRACT

A visualization method of manufacturing status is implemented by a computer that visualizes manufacturing status of a product manufactured sequentially by a plurality of processes. The visualization method includes: placing a first symbol that indicates a start and an end of the manufacturing of the product in a first process of the processes on a first temporal axis of the first process with a width corresponding to a time taken from the start to the end of the manufacturing in the first process, and a second symbol that indicates a start and an end of the manufacturing of the product in a second process following the first process on a second temporal axis of the second process with a width corresponding to a time taken from the start to the end of the manufacturing in the second process, the first and the second temporal axes extending in a same direction.

### CROSS-REFERENCE TO RELATED APPLICATION

This application is based upon and claims the benefit of priority of the prior Japanese Patent Application No. 2013-209707, filed on Oct. 4, 2013, the entire contents of which are incorporated herein by reference.

### FIELD

The embodiments discussed herein are related to a visualization method, a display method, a display device, and a display program.

### BACKGROUND

There have been systems that manufacture products through a plurality of processes. Devices are also available that assist estimating the causes from abnormalities occurring in such systems. In an example of such devices, an image is produced that visualizes a cause-effect relation when detecting an abnormality. In such a visualization image, areas are provided for respective processes and the leftmost area is the area for the process at the uppermost stream and followed by the areas for the downstream processes on the right side. Refer to Japanese Laid-open Patent Publication No. 2009-116842, for example.

However, it is difficult for such a related art device to display a manufacturing time and a waiting time of each process in a visually recognizable manner. As a result, it is difficult for a user to readily grasp the manufacturing time and the waiting time of each process. For example, it is also difficult for the user to identify the process that is asked to improve out of a plurality of processes.

### SUMMARY

According to an aspect of the embodiments, a visualization method of manufacturing status is implemented by a computer that visualizes manufacturing status of a product manufactured sequentially by a plurality of processes. The visualization method includes: placing a first symbol that indicates a start and an end of the manufacturing of the product in a first process of the processes on a first temporal axis of the first process with a width corresponding to a time taken from the start to the end of the manufacturing in the first process, and a second symbol that indicates a start and an end of the manufacturing of the product in a second process following the first process on a second temporal axis of the second process with a width corresponding to a time taken from the start to the end of the manufacturing in the second process, the first and the second temporal axes extending in a same direction, using a processor; forming a first line that connects a part indicating the start of the manufacturing in the first symbol placed on the first temporal axis of the first process and a part indicating the start of the manufacturing in the second symbol placed on the second temporal axis of the second process, and a second line that connects another part indicating the end of the manufacturing in the first symbol and another part indicating the end of the manufacturing in the second symbol, using the processor; outputting lines indicating the first and the second temporal axes, the first symbol, and the second symbol, using the processor; and outputting an area defined by the first symbol, the first line, the second symbol, and the second line in a visually recognizable color, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a structure of a display device according to a first embodiment;

FIG. 2 is a schematic diagram illustrating an example of a data structure of a history database (DB);

FIG. 3 is a schematic diagram to explain processing performed by a placement unit;

FIG. 4 is a schematic diagram to explain processing performed by a formation unit;

FIG. 5 is a schematic diagram to explain processing performed by an output unit;

FIG. 6 is a schematic diagram illustrating a flow of processing performed by the display device according to the first embodiment;

FIG. 7 is a functional block diagram illustrating a structure of a display device according to a second embodiment;

FIG. 8 is a schematic diagram illustrating an example of a data structure of a log DB;

FIG. 9 is a schematic diagram to explain processing performed by an identifying unit;

FIG. 10 is a schematic diagram illustrating a first example to explain the processing performed by the placement unit;

FIG. 11 is a schematic diagram illustrating a second example to explain the processing performed by the placement unit;

FIG. 12 is a schematic diagram illustrating a third example to explain the processing performed by the placement unit;

FIG. 13 is a schematic diagram illustrating an example of a graph displayed by the display unit;

FIG. 14 is a schematic diagram illustrating a flow of processing performed by the display device according to the second embodiment;

FIG. 15 is a schematic diagram illustrating a display example output from the display unit according to the second embodiment;

FIG. 16 is a schematic diagram to explain an example when the display device adjusts distances between temporal axes;

FIG. 17 is a schematic diagram to explain an example when the display device extends bands;

FIG. 18 is a schematic diagram to explain processing performed by the output unit when displaying a stripe background pattern in the graph;

FIG. 19 is a schematic diagram illustrating an example of the processing performed by the placement unit when pins, each of which indicates an event or an error occurring in a corresponding process, are displayed;

FIG. 20 is a schematic diagram illustrating an example of a graph output by combining a plurality of graphs;

FIG. 21 is a schematic diagram to explain the processing performed by the output unit that combines the plurality of graphs;

FIG. 22 is a schematic diagram illustrating an example of a graph when a manufacturing starting time and a manufacturing ending time are represented using a single line;

FIG. 23 is a schematic diagram illustrating a first example to explain the processing performed by the display device when managing the number of products in process;

FIG. 24 is a schematic diagram illustrating a second example to explain the processing performed by the display device when managing the number of products in process; and

FIG. 25 is a schematic diagram illustrating a hardware structure of a computer used in the display device of the first or the second embodiment.

### DESCRIPTION OF EMBODIMENTS

Preferred embodiments will be explained with reference to accompanying drawings. The embodiments do not limit the invention. The embodiments can be performed in any combination of them without inconsistency among them.

### [a] First Embodiment

Functional Structure of Display Device

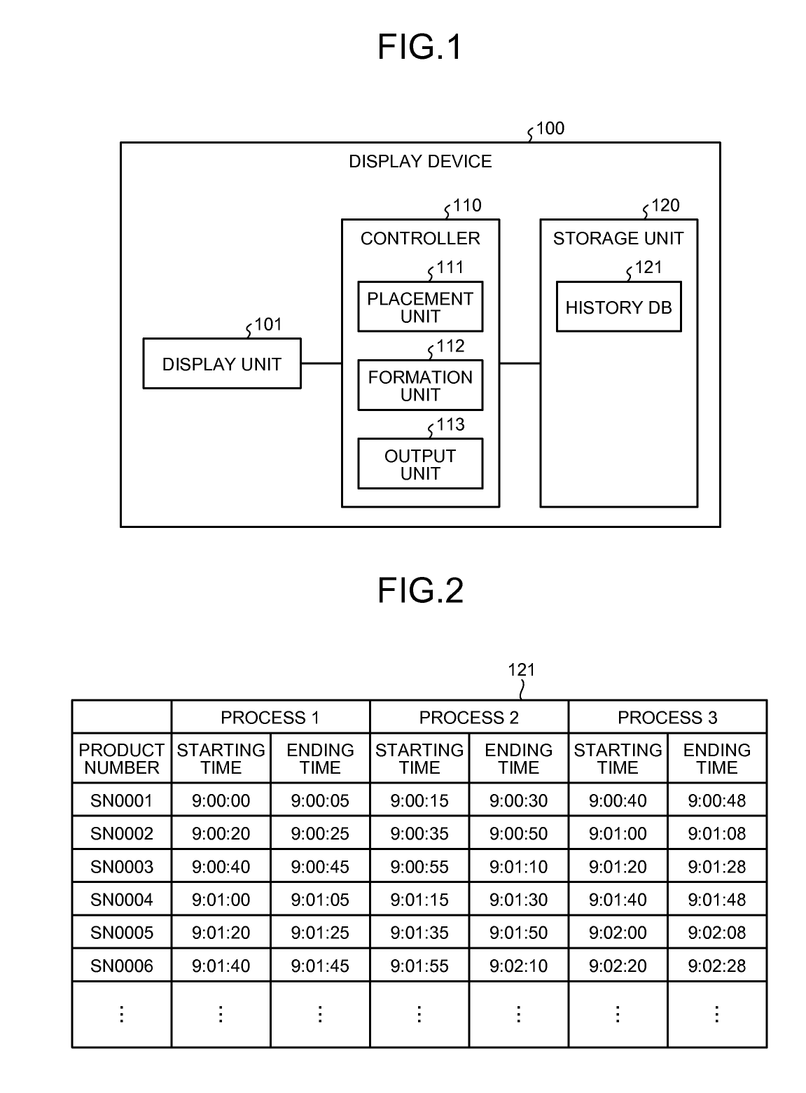

The following describes an example of a functional structure of a display device 100 according to a first embodiment. FIG. 1 is a functional block diagram illustrating the structure of the display device according to the first embodiment. As illustrated in FIG. 1, the display device 100 includes a display unit 101, a controller 110, and a storage unit 120. The display unit 101 displays a result of processing performed by the display device 100 on a monitor. Details of display data displayed on the display unit 101 are described later.

Structure of Storage Unit

The storage unit 120 stores therein various types of information for visualizing manufacturing status of a product in each manufacturing process, the product being manufactured by a plurality of processes sequentially performed. The storage unit 120 includes a history database (DB) 121, for example. The storage unit 120 is a semiconductor memory element such as a random access memory (RAM), a read only memory (ROM), or a flash memory, or a storage device such as a hard disk drive or an optical disc drive.

The history DB 121 is a database that stores therein a history of the product, which is manufactured by the plurality of processes sequentially performed, in each manufacturing process. Specifically, the history DB 121 stores therein a time when the manufacturing starts and a time when the manufacturing ends in each process for each product as the history. FIG. 2 is a schematic diagram illustrating an example of a data structure of the history DB. In the example illustrated in FIG. 2, the history DB 121 associates a product number with a starting time and an ending time of the manufacturing in the process for each process. The “product number” is a number uniquely allocated for each product manufactured in a factory. The “starting time” indicates a time when the manufacturing starts in a corresponding process. The “ending time” indicates a time when the manufacturing ends in a corresponding process.

For example, a first record of the history DB 121 indicates that a process 1 of a product having a product number “SN0001” starts at “9:00:00” and ends at “9:00:05”. The first record of the history DB 121 indicates that a process 2 of the product having the product number “SN0001” starts at “9:00:15” and ends at “9:00:30”. The first record of the history DB 121 indicates that a process 3 of the product having the product number “SN0001” starts at “09:00:40” and ends at “09:00:48”. A second record of the history DB 121 indicates that the process 1 of the product having a product number “SN0002” starts at “9:00:20” and ends at “9:00:25”. The history DB 121 indicates the starting time and the ending time in each process in other records. In the example illustrated in FIG. 2, the data about the respective items are stored in association with one another as the records. The data may be stored in a different manner from that illustrated in FIG. 2 as long as the relation is maintained among the items associated with one another as described above.

Structure of Controller

The controller 110 performs control for visualizing the manufacturing status of the product in each manufacturing process, the product being manufactured by the plurality of processes sequentially performed. The controller 110 includes a placement unit 111, a formation unit 112, and an output unit 113, for example. The functions of the controller 110 can be achieved by a central processing unit (CPU) that executes a certain program, for example. The functions of the controller 110 can be achieved by an integrated circuit such as an application specific integrated circuit (ASIC) or a field programmable gate array (FPGA).

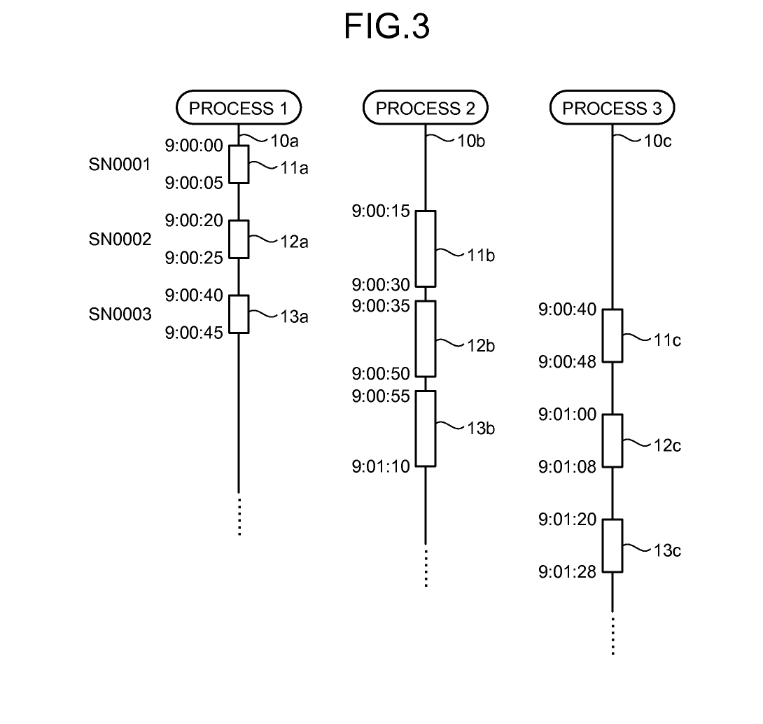

The placement unit 111 places a symbol that indicates the start and the end of the manufacturing of a certain product on a temporal axis of each of a first process and a second process such that the width of the symbol corresponds to a time taken from the start to the end of the manufacturing. The temporal axes of the first and the second processes extend in the same direction. The following describes processing performed by the placement unit 111 with reference to FIG. 3. FIG. 3 is a schematic diagram to explain the processing performed by the placement unit. The placement unit 111 acquires a time when the manufacturing starts and a time when the manufacturing ends in each process from the history DB 121. The placement unit 111 places the symbols each indicating the time when the manufacturing starts and the time when the manufacturing ends in the process on respective temporal axes 10a, 10b, and 10c of the respective processes, the temporal axes extending in parallel with one another. The temporal axes 10a, 10b, and 10c correspond to the process 1, the process 2, and the process 3, respectively. In the following description, a time when the manufacturing starts is referred to as a manufacturing starting time while a time when the manufacturing ends is referred to as a manufacturing ending time.

The placement unit 111 performs the following processing, for example. The placement unit 111 acquires, about the product having the product number “SN0001”, the manufacturing starting time “9:00:00” and the manufacturing ending time “9:00:05” in the process 1. The placement unit 111 acquires, about the product having the product number “SN0001”, the manufacturing starting time “9:00:15” and the manufacturing ending time “9:00:30” in the process 2. The placement unit 111 acquires, about the product having the product number “SN0001”, the manufacturing starting time “9:00:40” and the manufacturing ending time “9:00:48” in the process 3. The placement unit 111 acquires the manufacturing starting and ending times about the product having the product number “SN0002” and the product having the product number “SN0003” in the same manner as described above.

The placement unit 111 places a symbol 11a on the temporal axis 10a extending from the process 1 illustrated in FIG. 3 based on the manufacturing starting time “9:00:00” and the manufacturing ending time “9:00:05” in the process 1 about the product having the product number “SN0001”. The placement unit 111 places a symbol 11b on the temporal axis 10b extending from the process 2 illustrated in FIG. 3 based on the manufacturing starting time “9:00:15” and the manufacturing ending time “9:00:30” in the process 2 about the product having the product number “SN0001”. The placement unit 111 places a symbol 11c on the temporal axis 10c extending from the process 3 illustrated in FIG. 3 based on the manufacturing starting time “9:00:40” and the manufacturing ending time “9:00:48” in the process 3 about the product having the product number “SN0001”.

The width of the symbol placed by the placement unit 111 corresponds to the time taken from the start to the end of the manufacturing in the temporal axis direction. For example, a time taken in the process 1 about the product having the product number “SN0001” is five seconds, a time taken in the process 2 about the product having the product number “SN0001” is 15 seconds, and thus the ratio of the width of the symbol in the process 1 to that in the process 2 is one to three. The information about the placement (placement information) determined by the processing performed by the placement unit 111 is stored in the storage unit 120 or a memory of the controller 110 as image information, such as one illustrated in FIG. 3. The information stored as the placement information is not limited to the image information, and may be information that indicates coordinates where the symbols are placed or information that indicates the sizes of the widths in an image displayed by the display unit 101.

The formation unit 112 forms a first line that connects the part indicating the start of the manufacturing in a first symbol placed on the temporal axis of a first process and the part indicating the start of the manufacturing in a second symbol placed on the temporal axis of a second process. The formation unit 112 forms a second line that connects the part indicating the end of the manufacturing in the first symbol and the part indicating the end of the manufacturing in the second symbol.

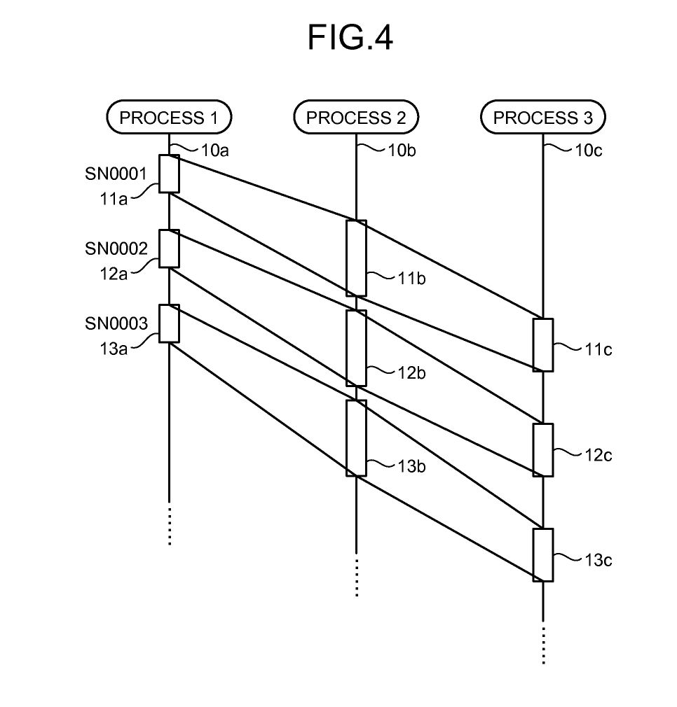

The following describes processing performed by the formation unit 112 with reference to FIG. 4. FIG. 4 is a schematic diagram to explain the processing performed by the formation unit. The formation unit 112 forms the line that connects the manufacturing starting time in the process 1 and the manufacturing starting time in the process 2 of the product having the product number of “SN0001”. Likewise, the formation unit 112 forms the line that connects the manufacturing ending time in the process 1 and the manufacturing ending time in the process 2 of the product having the product number of “SN0001”. The formation unit 112 then forms the line that connects the manufacturing starting time in the process 2 and the manufacturing starting time in the process 3 of the product having the product number of “SN0001”. Likewise, the formation unit 112 forms the line that connects the manufacturing ending time in the process 2 and the manufacturing ending time in the process 3 of the product having the product number of “SN0001”. In this way, the formation unit 112 forms the line that connects the manufacturing starting times between the processes 1 and 2, and the line that connects the manufacturing starting times between the processes 2 and 3, and likewise, forms the line that connects the manufacturing ending times between the processes 1 and 2, and the line that connects the manufacturing ending times between the processes 2 and 3. As a result, the formation unit 112 forms zonal areas that indicate relations of a manufacturing time and a waiting time between the processes about the product having the product number of “SN0001”. The formation unit 112 performs the processing to form the lines about the product having the product number “SN0002” and the product having the product number “SN0003” in the same manner as described above. The information about the lines (line information) formed by the processing performed by the formation unit 112 is stored in the storage unit 120 or the memory of the controller 110 as the image information, such as one illustrated in FIG. 4. The information stored as the line information is not limited to the image information, and may be information that indicates coordinates where the lines are placed in the image displayed by the display unit 101.

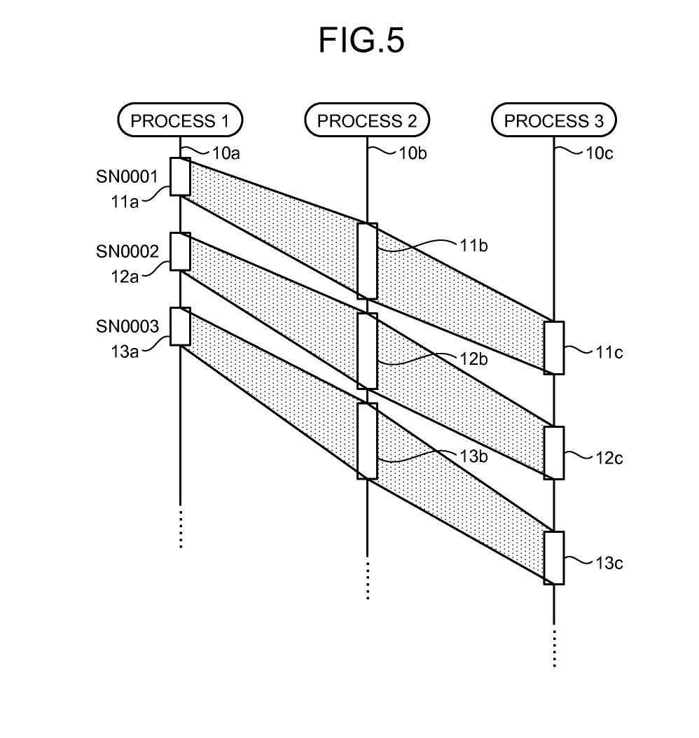

The output unit 113 outputs the lines indicating the temporal axes, the first symbol, and the second symbol, and outputs the area defined by the first symbol, the first line, the second symbol, and the second line in a visually recognizable color. The following describes processing performed by the output unit 113 with reference to FIG. 5. FIG. 5 is a schematic diagram to explain the processing performed by the output unit. The output unit 113 outputs the zonal areas indicating the manufacturing times about the respective products numbers “SN0001”, “SN0002”, and “SN0003” to the display unit 101 by coloring the respective zonal areas in certain colors that are distinguishable from at least the surrounding areas. For example, the output unit 113 outputs the areas indicating the manufacturing times in a dark color while the output unit 113 outputs the areas indicating the waiting times in a faint color or in white. The display unit 101 displays the image information, such as the one illustrated in FIG. 5, based on the output from the output unit 113. As a result, an image is produced that indicates the manufacturing times and the waiting times of the respective processes for each product. The output of such an image makes it possible for a user to visually recognize and readily grasp the manufacturing times and the waiting times of the respective processes for each product. The output unit 113 outputs the image information, e.g., as illustrated in FIG. 4, stored in the storage unit 120 or the memory of the controller 110 to the display unit 101 after coloring the image information. The image information may be produced, such as the one illustrated in FIG. 5, based on the coordinates of the symbols determined by the placement unit 111 and the coordinates of the lines formed by the formation unit 112 without being stored, and the produced image may be output.

Flow of Processing Performed by Display Device According to First Embodiment

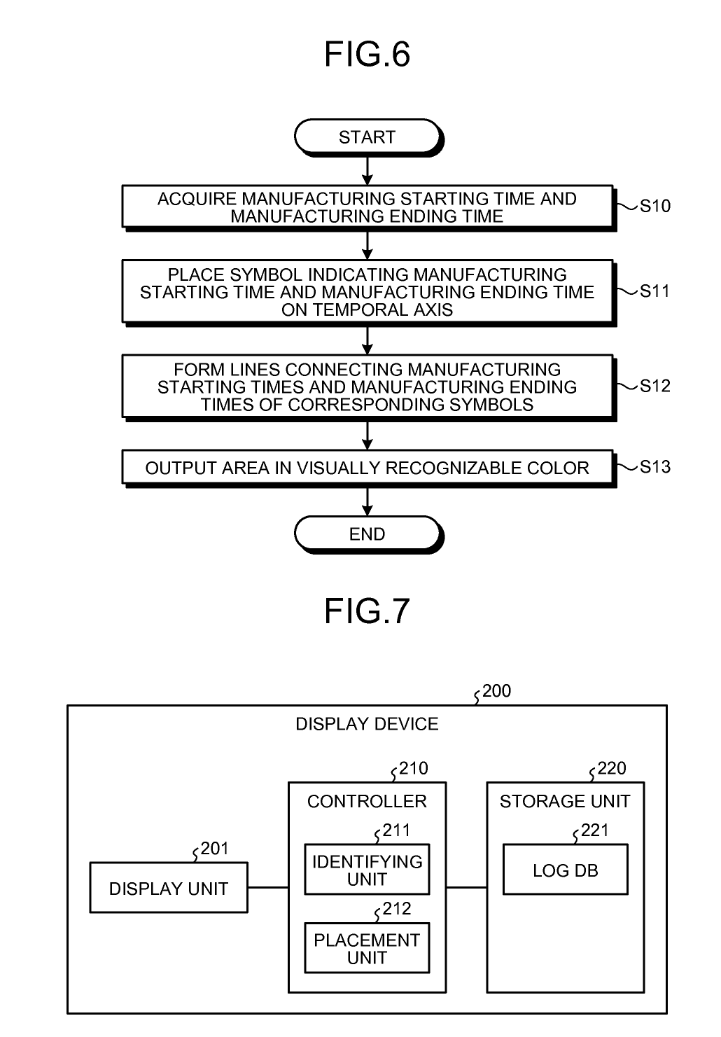

The following describes a flow of the processing performed by the display device 100 with reference to FIG. 6. FIG. 6 is a schematic diagram illustrating a flow of the processing performed by the display device according to the first embodiment. The placement unit 111 acquires a time when the manufacturing starts and a time when the manufacturing ends in each process from the history DB 121 (step S10). The placement unit 111 places the symbols that indicate the manufacturing starting times and the manufacturing ending times in the respective processes on the temporal axes corresponding to the respective processes (step S11).

The formation unit 112 forms the lines that connect the manufacturing starting times and the manufacturing ending times of the corresponding symbols (step S12). The formation unit 112 forms the lines that connect the manufacturing starting times and the manufacturing ending times between the processes in a series of processes about the respective products, thereby forming the zonal areas that indicate the manufacturing times and the waiting times between the processes in the series of processes. The output unit 113 outputs the zonal areas about the respective products in individually visually recognizable colors (step S13). For example, the output unit 113 outputs the areas indicating the manufacturing times in a dark color while the output unit 113 outputs the areas indicating the waiting times in a faint color or in white.

Advantageous Effects of Display Device of First Modification

As described above, the display device 100 visualizes the manufacturing status of the product manufactured by the plurality of processes sequentially performed. The display device 100 performs the following processing on the first process and the second process following the first process out of the plurality of processes. The placement unit 111 places the symbol that indicates the start and the end of the manufacturing of a product on the temporal axis of each of the first and the second processes such that the width of the symbol corresponds to a time taken from the start to the end of the manufacturing. The temporal axes of the first and the second processes extend in the same direction. The formation unit 112 forms the first line that connects the part indicating the start of the manufacturing in the first symbol placed on the temporal axis of the first process and the part indicating the start of the manufacturing in the second symbol placed on the temporal axis of the second process. The formation unit 112 forms the second line that connects the part indicating the end of the manufacturing in the first symbol and the part indicating the end of the manufacturing in the second symbol. The output unit 113 outputs the lines indicating the temporal axes, the first symbol, and the second symbol, and outputs the area defined by the first symbol, the first line, the second symbol, and the second line in a visually recognizable color.

As a result, the manufacturing time and the waiting time of each process can be displayed in a visually recognizable manner. For example, FIG. 5, which is an example of the output of the display device 100, makes it possible to display at one view how the respective products are manufactured in the respective processes in a visually recognizable manner with the manufacturing times and the waiting times. As a result, such an output screen makes it possible for a user who views the screen to readily identify the processes that are asked to improve.

A technique may be available in which traceability information is checked with only the detected defective product after a defective product is detected. The display device 100 according to the first embodiment can visually express the traceability information about all of the products. The status of a defective product in the respective processes and the status of a conforming product in the respective processes are displayed on the screen as a difference in shape of their zonal areas, thereby making it possible to give the difference between the conforming product and the defective product to a manager. The display device 100 enables a manager to readily visually identify the process and a time zone where a problem occurs from a density of the zonal areas indicating the manufacturing times or the widths of the zonal areas indicating the waiting times, thereby making it possible for the manager to intuitively grasp influential factors of product quality, for example.

A technique may also be available in which a manufacturing time taken to manufacture an interim product and a waiting time to manufacture the next interim product is calculated for each product in each process from a time when the manufacturing of the product starts and a time when the manufacturing of the product ends, and the resulting time information is displayed. The technique, however, only lists the respective manufacturing times and the respective waiting times in numbers. Although a manager checks the list of the numbers, it takes time for a manager to identify the process and an apparatus where a problem occurs. In contrast, the display device 100 according to the first embodiment makes it possible to cause a manager to visually grasp the respective manufacturing times and the respective waiting times and furthermore to visually identify the process where a problem occurs.

### [b] Second Embodiment

Functional Structure of Display Device

The following describes an example of a functional structure of a display device 200 according to a second embodiment. FIG. 7 is a functional block diagram illustrating the structure of the display device according to the second embodiment. As illustrated in FIG. 7, the display device 200 includes a display unit 201, a controller 210, and a storage unit 220. The display unit 201 displays a result of processing performed by the display device 200 on a monitor. Details of display data displayed on the display unit 201 are described later. The storage unit 220 is a semiconductor memory element such as a RAM, a ROM, or a flash memory, or a storage device such as a hard disk drive or an optical disc drive. The functions of the controller 210 can be achieved by a CPU that executes a certain program, for example. The functions of the controller 210 can be achieved by an integrated circuit such as an ASIC or an FPGA.

Structure of Storage Unit

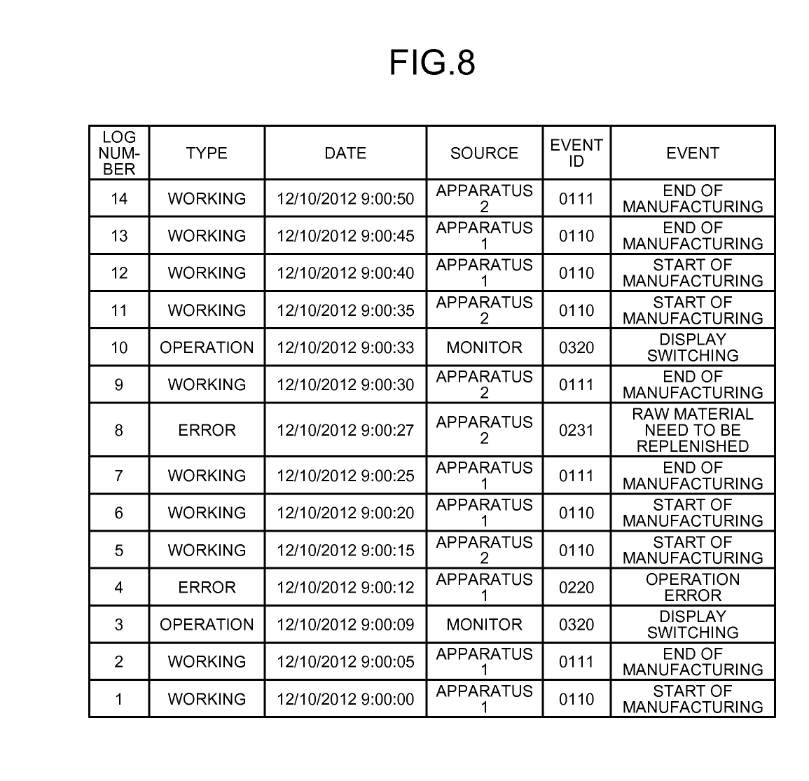

The storage unit 220 stores therein various types of information for processing to display the manufacturing status. The storage unit 220 includes a log DB 221, for example. The log DB 221 stores therein log information about processing performed by apparatuses included in a manufacturing line. The log DB 221 is a database that stores therein types of occurring events, sources where the events occur, contents of the occurring events in chronological order. FIG. 8 is a schematic diagram illustrating an example of a data structure of the log DB. In the example illustrated in FIG. 8, the log DG 221 associates a log number, a type, a date, a source, an event ID, and an event with one another. The “log numbers” are allocated in ascending order from the latest occurring event log. In the log DB 221, which displays the event logs in the order of latest log first, the log numbers are displayed in descending order. The logs may be displayed in different order from that in FIG. 8. The “type” indicates a type of the event log. The “date” indicates the date and the time when an event or an error occurs. The “source” indicates an apparatus where an event or an error occurs. The “event ID” is a number uniquely allocated for each event or error. The “event” indicates a content of the event corresponding to the event ID.

For example, in the log DB 221, the record having a log number “1” indicates that the type is “working”, the time is “9:00:00” and the date is “12/10/2012 (Dec. 10, 2012)”, the source is an “apparatus 1”, the event ID is “0110”, and the event is “start of manufacturing”. In the log DB 221, the record having a log number “2” indicates that the type is “working”, the time is “9:00:05” and the date is “Dec. 10, 2012”, the source is the “apparatus 1”, the event ID is “0111”, and the event is “end of manufacturing”. In the log DB 221, the record having a log number “3” indicates that the type is “operation”, the time is “9:00:09” and the date is “Dec. 10, 2012”, the source is a “monitor”, the event ID is “0320”, and the event is “display switching”. In the log DB 221, the records having other log numbers also indicate the log information in the same manner as described above.

The types of event logs are classified into three groups of a working-related log, an operation-related log, and an error-related log. In the log DB 221, the event log whose “type” is “working” is the working-related log. The working-related log is recorded when a certain apparatus starts and ends the manufacturing of an interim product, for example. In the log DB 221, the event log whose “type” is “operation” is the operation-related log. The operation-related log is recorded when the screen is operated, e.g., a display switching button in a displayed window is pressed down. In the log DB 221, the event log whose “type” is “error” is the error-related log. The error-related log is recorded when any error occurs in a certain apparatus, e.g., a remaining amount of raw material used for manufacturing an interim product by the apparatus is less than a certain threshold. In the example illustrated in FIG. 8, the data about the respective items are stored in association with one another as the records. The data may be stored in a different manner from that illustrated in FIG. 2 as long as the relation is maintained among the items associated with one another as described above.

Structure of Controller

The controller 210 performs control for processing to display the manufacturing status. The controller 210 includes an identifying unit 211 and a placement unit 212, for example. Processing performed by the identifying unit 211 is described. The identifying unit 211 identifies a processing period and a waiting period of a first apparatus included in a manufacturing line and the processing period and the waiting period of a second apparatus included in the manufacturing line and performing processing after processing in the first apparatus, based on the log information about the processing in the first apparatus and the log information about the processing in the second apparatus.

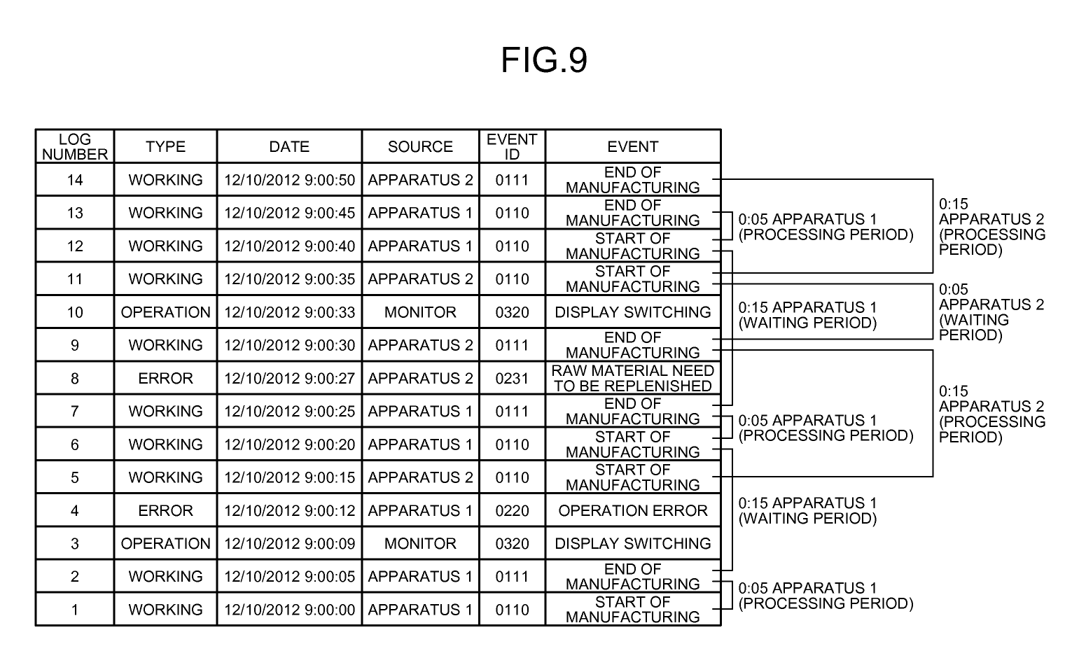

The following describes processing performed by the identifying unit 211 with reference to FIG. 9. FIG. 9 is a schematic diagram to explain the processing performed by the identifying unit. The logs about an apparatus 3 are omitted in FIG. 9. The identifying unit 211 acquires the logs indicating the start of manufacturing and the end of manufacturing from the working-related logs about the apparatus 1 and an apparatus 2 out of the logs included in the log DB 221 of FIG. 9. Specifically, the identifying unit 211 acquires the logs corresponding to the event IDs “0110” and “0111”, which correspond to the working-related log, out of the logs included in the log DB 221.

For example, the identifying unit 211 acquires the log having a log number “1”, which indicates the start of the manufacturing by the apparatus 1, and the log having a log number “2”, which indicates the end of the manufacturing by the apparatus 1. Then, the identifying unit 211 subtracts the occurrence time “9:00:00” of the event having the log number “1” from an occurrence time “9:00:05” of the event having the log number “2”. As a result, the identifying unit 211 identifies the processing period “0:05” of the apparatus 1. The identifying unit 211 acquires the log having the log number “2”, which indicates the end of the manufacturing by the apparatus 1, and the log having a log number “6”, which indicates the start of the manufacturing by the apparatus 1. Then, the identifying unit 211 subtracts the occurrence time “9:00:05” of the log having the log number “2” from the occurrence time “9:00:20” of the log having the log number “6”. As a result, the identifying unit 211 identifies the waiting period “0:15” of the apparatus 1. The identifying unit 211 acquires the log having the log number “6”, which indicates the start of the manufacturing by the apparatus 1, and the log having a log number “7”, which indicates the end of the manufacturing by the apparatus 1. Then, the identifying unit 211 subtracts the occurrence time “9:00:20” of the log having the log number “6” from the occurrence time “9:00:25” of the log having the log number “7”. As a result, the identifying unit 211 identifies the processing period “0:05” of the apparatus 1. The identifying unit 211 identifies the other processing periods and the waiting periods about the apparatus 1.

Likewise, the identifying unit 211 acquires the log having a log number “5”, which indicates the start of the manufacturing by the apparatus 2, and the log having a log number “9”, which indicates the end of the manufacturing by the apparatus 2. Then, the identifying unit 211 subtracts the occurrence time “9:00:15” of the log having the log number “5” from the occurrence time “9:00:30” of the log having the log number “9”. As a result, the identifying unit 211 identifies the processing period “0:15” of the apparatus 2. The identifying unit 211 acquires the log having the log number “9”, which indicates the end of the manufacturing by the apparatus 2, and the log having a log number “11”, which indicates the start of the manufacturing by the apparatus 2. Then, the identifying unit 211 subtracts the occurrence time “9:00:30” of the log having the log number “9” from the occurrence time “9:00:35” of the log having the log number “11”. As a result, the identifying unit 211 identifies the waiting period “0:05” of the apparatus 2. The identifying unit 211 identifies the other processing periods and the waiting periods about the apparatus 2. The identifying unit 211 identifies the other processing periods and the waiting periods about the apparatus 3.

The identifying unit 211 acquires the respective times when the apparatuses initially start the manufacturing in order to identify the acquired respective processing periods and the waiting periods on the corresponding temporal axes. For example, the identifying unit 211 acquires “9:00:00 on Dec. 10, 2012”, which is the time when the apparatus 1 initially starts the manufacturing from the log having the log number “1”. The identifying unit 211 acquires “9:00:15 on Dec. 10, 2012”, which is the time when the apparatus 2 initially starts the manufacturing from the log having the log number “5”. The identifying unit 211 uses the respective times when the apparatuses initially start the manufacturing in order to identify the acquired respective processing periods and the waiting periods on the corresponding temporal axes.

The processing periods, the waiting periods, and the respective times when the apparatuses initially start the manufacturing that are identified by the identifying unit 211 are stored in the storage unit 220 or the memory of the controller 210. The information stored in the memory is used by the placement unit 212, which is described later.

The following describes an example of processing performed by the placement unit 212. The placement unit 212 places the identified processing periods and the waiting periods of the first apparatus on a first temporal axis that indicates a change in processing and waiting periods of the first apparatus. The placement unit 212 places the identified processing periods and the waiting periods of the second apparatus on a second temporal axis that indicates a change in processing and waiting periods of the second apparatus and is in parallel with the first temporal axis. The placement unit 212 forms a first band and a second band. The first band connects the processing periods of a manufacturing product in common between the first and the second apparatuses while the second band connects the waiting periods of the manufacturing product in common between the first and the second apparatuses. The placement unit 212 displays, on the display unit 201, the transition of the processing periods and the waiting periods as stripes of different bands. The placement unit 212 places the symbols indicating the processing and the waiting periods of the respective apparatuses that are specified by the identifying unit 211. The placement unit 212, then, forms the first bands indicating the processing periods of the common manufacturing products and the second bands indicating the waiting periods of the common manufacturing products based on the placed processing and waiting periods of the respective apparatuses. The band is a polygonal zonal area that connects the processing periods to each other.

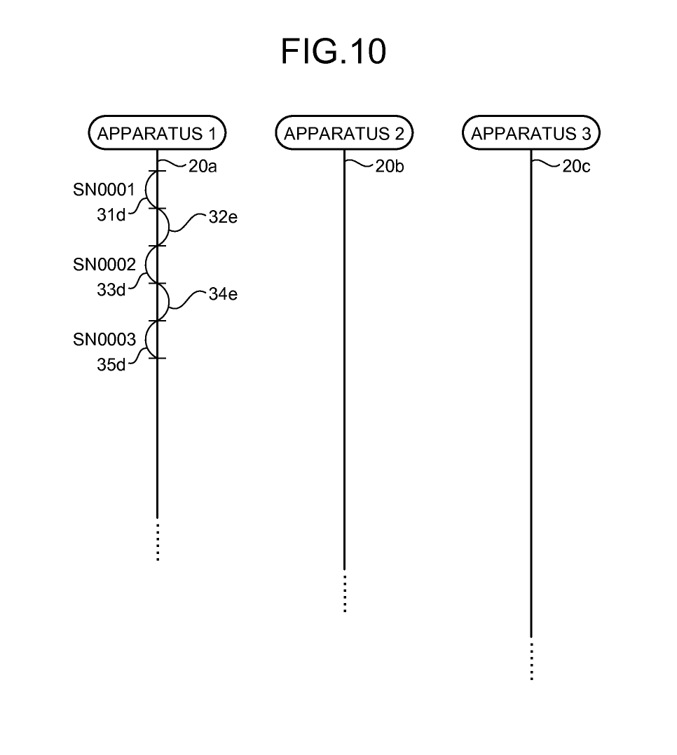

The following describes an example of the processing performed by the placement unit 212 with reference to FIGS. 10 to 13. FIG. 10 is a schematic diagram illustrating a first example to explain the processing performed by the placement unit. The placement unit 212 places a symbol that indicates a processing period 31d on a temporal axis 20a of the apparatus 1 based on the time “9:00:00 on Dec. 10, 2012”, which is the time when the apparatus 1 initially starts the manufacturing, and the processing period “0:05” of the apparatus 1, the time and the period being acquired by the identifying unit 211. The placement unit 212 places a symbol that indicates a waiting period 32e after the processing period 31d on the temporal axis 20a of the apparatus 1 based on the waiting period “0:15” of the apparatus 1. The placement unit 212 places a symbol that indicates a processing period 33d after the waiting period 32e based on the processing period “0:05” of the apparatus 1. The placement unit 212 places a symbol that indicates a waiting period 34e after the processing period 33d based on the waiting period “0:15” of the apparatus 1. The placement unit 212 places a symbol that indicates a processing period 35d after the waiting period 34e based on the processing period “0:05” of the apparatus 1.

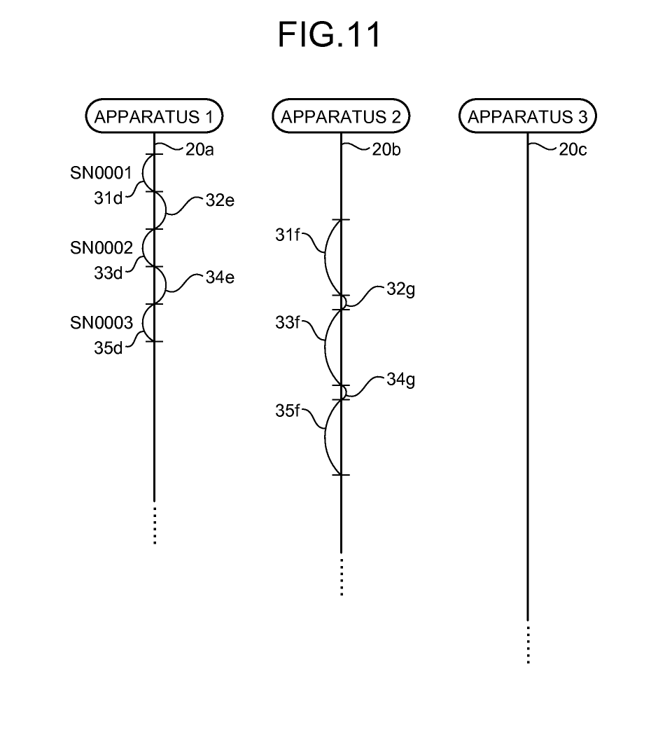

FIG. 11 is a schematic diagram illustrating a second example to explain the processing performed by the placement unit. The placement unit 212 places a symbol that indicates a processing period 31f on a temporal axis 20b of the apparatus 2 based on the time “9:00:15 on Dec. 10, 2012”, which is the time when the apparatus 2 initially starts the manufacturing, and the processing period “0:15” of the apparatus 2, the time and the period being acquired by the identifying unit 211. The placement unit 212 places a symbol that indicates a waiting period 32g after the processing period 31f on the temporal axis 20b of the apparatus 2 based on the waiting period “0:05” of the apparatus 2. The placement unit 212 places a symbol that indicates a processing period 33f after the waiting period 32g on the temporal axis 20b of the apparatus 2 based on the processing period “0:15” of the apparatus 2. The placement unit 212 places a symbol that indicates a waiting period 34g and a symbol that indicates a processing period 35f in the same manner as described above. The placement unit 212 places the symbols indicating the processing and the waiting periods about the apparatus 3 in the same manner as described above.

The width of the symbol placed by the placement unit 212 corresponds to the processing period or the waiting period in the temporal axis direction. For example, when the processing period of the apparatus 1 is “0:05” while the waiting period of the apparatus 1 is “0:15”, the ratio of the width of the processing period to that of the waiting period is one to three. The placement information determined by the processing performed by the placement unit 212 is stored in the storage unit 120 or the memory of the controller 110 as the image information, such as the one illustrated in FIG. 3. The information stored as the placement information is not limited to the image information, and may be information that indicates an image of the placed symbols or information that indicates the sizes of the widths in an image displayed by the display unit 201.

The information about positions (position information) of the processing and the waiting periods that are placed by the placement unit 212 is stored, as coordinate information, in the storage unit 220 or the memory of the controller 210, for example. The information stored in the memory is used by the placement unit 212, which will be described later.

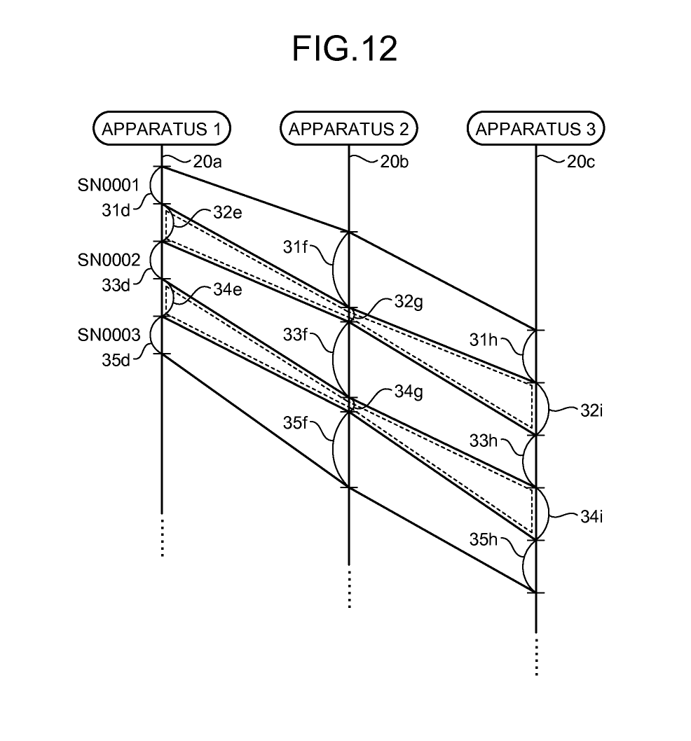

FIG. 12 is a schematic diagram illustrating a third example to explain the processing performed by the placement unit. The placement unit 212 forms the first band that connects the processing periods 31d, 31f, and 31h of a manufacturing product “SN0001”. The placement unit 212 forms the second band that connects the waiting periods 32e, 32g, and 32i between the manufacturing products “SN0001” and “SN0002”. The placement unit 212 forms the first band that connects the processing periods 33d, 33f, and 33h of the manufacturing product “SN0002”. The placement unit 212 forms the second band that connects the waiting periods 34e, 34g, and 34i between the manufacturing products “SN0002” and “SN0003”. The placement unit 212 forms the first band that connects the processing periods 35d, 35f, and 35h of the manufacturing product “SN0003”. In FIG. 12, the second bands are depicted with the dotted lines.

The placement unit 212 stores the formed first and the second bands in the storage unit 220 or the memory of the controller 210 as the image information, such as the one illustrated in FIG. 12. The information stored in the memory is used by the display unit 201, which is described later.

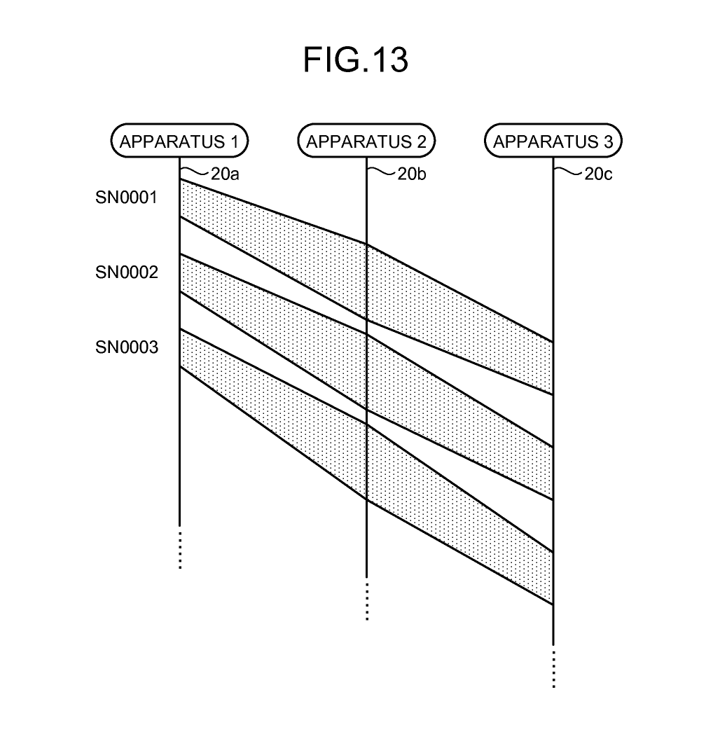

The placement unit 212 displays the transition of the processing periods and the waiting periods as the stripes of different bands. FIG. 13 is a schematic diagram illustrating an example of a graph displayed by the placement unit. For example, the placement unit 212 colors the first bands relating to the manufacturing products “SN0001”, “SN0002”, and “SN0003” in a certain color and displays the graph as stripes of the bands. The placement unit 212 may color the stripes of the second bands relating to the manufacturing products “SN0001”, “SN0002”, and “SN0003” in a color different from that of the first bands or may not color the stripes of the second bands. As described above, the placement unit 212 places the symbols indicating the processing and the waiting periods, forms the first and the second bands, and display the stripes on the display unit 201. The processing is not limited to that described above. For example, a formation unit may form the first and the second bands based on the symbols indicating the processing and the waiting periods, which are placed by the placement unit 212, and display the bands on the display unit 201.

Flow of Processing Performed by Display Device According to Second Embodiment

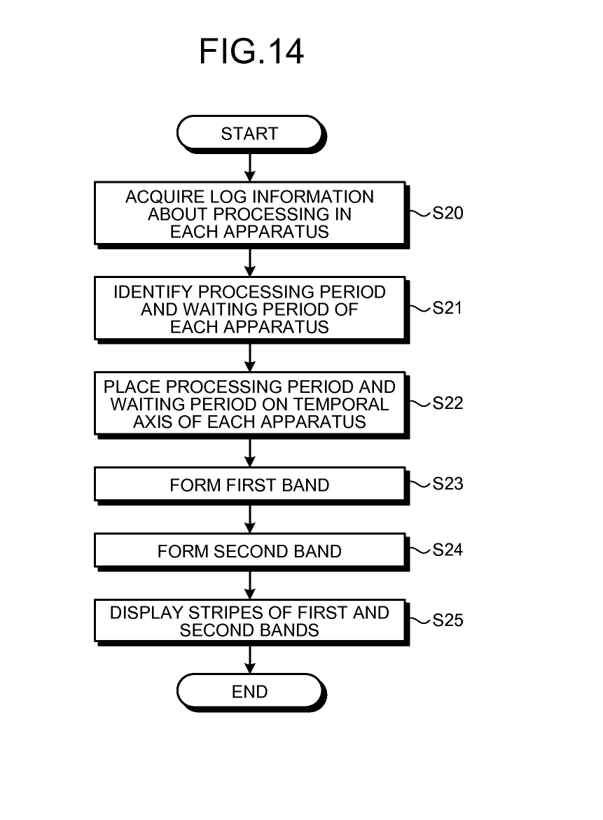

The following describes a flow of the processing performed by the display device 200 with reference to FIG. 14. FIG. 14 is a schematic diagram illustrating a flow of the processing performed by the display device according to the second embodiment. The identifying unit 211 acquires the log information about the processing performed by the respective apparatuses (step S20). For example, the identifying unit 211 acquires the logs indicating the manufacturing starting times and the manufacturing ending times in the respective apparatuses from the working-related logs of the log DB 221. The identifying unit 211 identifies the processing periods and the waiting periods of the respective apparatuses based on the logs indicating the manufacturing starting times and the manufacturing ending times of the respective apparatuses (step S21). For example, the identifying unit 211 identifies the waiting period of an interim product in a certain apparatus based on the log indicating the manufacturing ending time of another interim product manufactured just before the interim product and the log indicating the manufacturing starting time of the interim product. The identifying unit 211 identifies the processing period of an interim product in a certain apparatus based on the log indicating the manufacturing starting time of the interim product and the log indicating the manufacturing ending time of the interim product.

The placement unit 212 places the processing periods on the temporal axes of the respective apparatuses based on the processing periods of the respective apparatuses identified by the identifying unit 211 (step S22). The placement unit 212 places the waiting periods on the temporal axes of the respective apparatuses based on the waiting periods of the respective apparatuses identified by the identifying unit 211 (step S22).

The placement unit 212 forms the first band that connects the processing periods of the same manufacturing product in the respective apparatuses one another for each manufacturing product (step S23). For example, in the example illustrated in FIG. 12, the placement unit 212 forms the first band that connects the processing periods 31d, 31f, and 31h about the product “SN0001”. The placement unit 212 forms the second band that connects the waiting periods of the same manufacturing product in the respective apparatuses one another for each manufacturing product (step S24). For example, in the example illustrated in FIG. 12, the placement unit 212 forms the second band that connects the waiting periods 32e, 32g, and 32i about the product “SN0002”. The placement unit 212 colors the first bands in a dark color and the second bands in a faint color, and causes the display unit 201 to display the stripes of the first and the second bands (step S25).

Advantageous Effects of Display Device of Second Modification

As described above, the identifying unit 211 identifies the processing period and the waiting period of the first apparatus and the processing period and the waiting period of the second apparatus based on the log information about processing in the first apparatus included in the manufacturing line and the log information about processing in the second apparatus that is included in the manufacturing line and performs the processing after the processing in the first apparatus. The placement unit 212 places the identified processing and waiting periods of the first apparatus on the first temporal axis that indicates a change in processing and waiting periods of the first apparatus, and places the identified processing and waiting periods of the second apparatus on the second temporal axis that indicates a change in processing and waiting periods of the second apparatus and is in parallel with the first temporal axis. The placement unit 212 forms the first band and the second band. The first band connects the processing periods of the manufacturing product in common between the first and the second apparatuses while the second band connects the waiting periods of the manufacturing product in common between the first and the second apparatuses. The placement unit 212 displays the transition of the processing periods and the waiting periods as the stripes of the different bands.

As described above, a screen display can be made that displays the processing and the waiting periods in the respective apparatuses. For example, the display device 200 colors the first bands that indicate the processing periods in a dark color and the second bands that indicate the waiting periods in a faint color, thereby making it possible to produce a screen in which the whole of the graph becomes a dark color when the waiting periods are short while the whole of the graph becomes a faint color when the waiting periods are long. As a result, such a screen makes it possible for a user who views the screen to visually recognize at one view the productivity of the whole of the manufacturing line including the plurality of processes.

When a difference occurs in processing or waiting period between the one in the graph and an ideal one, the difference can be displayed as a difference in shape of the band. For example, the display device 200 can express that a lot of processing time is spent in the process the first band width of which is large, thereby making it possible for a manager to visually recognize at one view the process where the manufacturing of an interim product is delayed by paying attention to the width of the first band. As a result, the manager can readily identify the process that has to be maintained. Furthermore, the display device 200 can express that a lot of waiting time is spent in the process the second band width of which is large, thereby making it possible for a manager to visually recognize at one view the process where the manufacturing of an interim product is stagnating by paying attention to the width of the second band. As a result, the manager can identify the apparatus of which the setting has to be changed. For example, a torque of a conveyer that conveys the interim product between the apparatuses has to be increased.

Examples of Graph Display on Screen

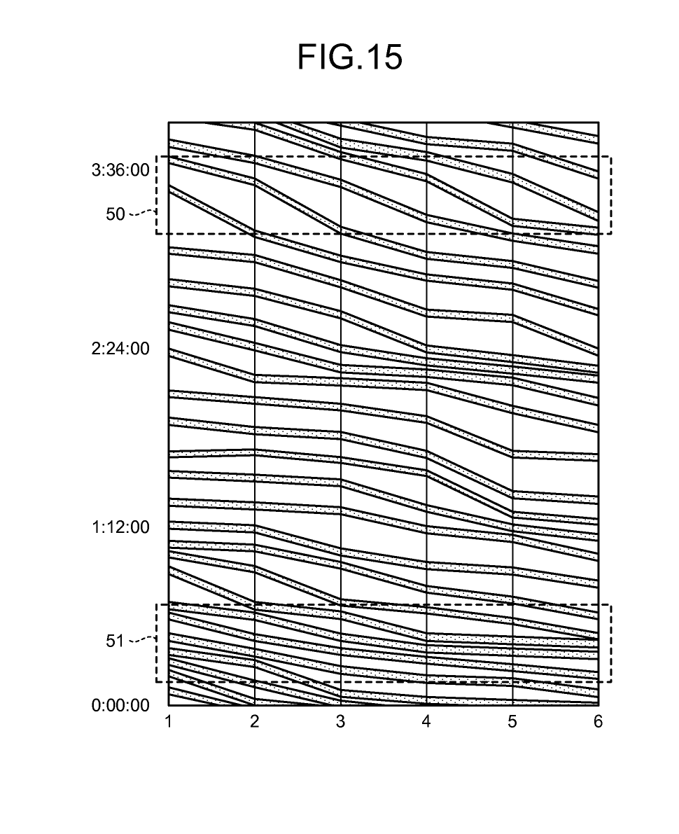

The following describes a display output from the display unit 201 with reference to FIG. 15. FIG. 15 is a schematic diagram illustrating an example of the display output from the display unit according to the second embodiment. As illustrated in FIG. 15, the display device 200 expresses the processing periods with colored bands. The display device 200 expresses the waiting periods with bands colored in white. With this display manner, the display device 200 can express that the manufacturing of the product is inefficient in a portion where the density of lines is low in the graph. In contrast, the display device 200 can express that the manufacturing of the product is efficient in a portion where the density of lines is high in the graph. As a result, the display device 200 makes it possible for a manager to visually grasp the process and the time where the manufacturing is inefficient. The display device 200 may color the bands indicating the processing periods in a dark color and the bands indicating the waiting periods in white. As a result, the display device 200 makes it possible for a manager to grasp a time range where the number of waiting periods is large based on color contrasting density.

For example, the density of lines is low in an area 50 of FIG. 15, as a result of the display of the display device 200. A manager who visually recognizes the area 50 can grasp that the manufacturing of the product is inefficient. In the area 50 of the display of the display device 200, the zonal areas in white are displayed larger than the colored zonal areas. A manager who visually recognizes the area 50 can grasp that the ratio of the waiting period to the processing period is large. In contrast, the density of lines is high in an area 51 of FIG. 15, as a result of the display of the display device 200. A manager who visually recognizes the area 51 can grasp that the manufacturing of the product is efficient. In this way, the display device 200 can display to a manager a portion where a problem occurs in a visually recognizable manner.

### [c] Third Embodiment

The following describes other examples that are applicable to the first and the second embodiments.

Adjustment of Distances Between Temporal Axes

The output unit 113 of the display device 100 or the formation unit 213 of the display device 200 may adjust distances between the temporal axes such that the upper sides of the areas or the first band become a straight line when the product is manufactured by a plurality of processes or a plurality of apparatuses by following respective standard manufacturing times. The standard manufacturing time may be preliminarily input by a manager to the display device 100 or the display device 200 and stored, or may be an average of the manufacturing times calculated from the event logs. In the following description, the standard manufacturing time is referred to as the standard time.

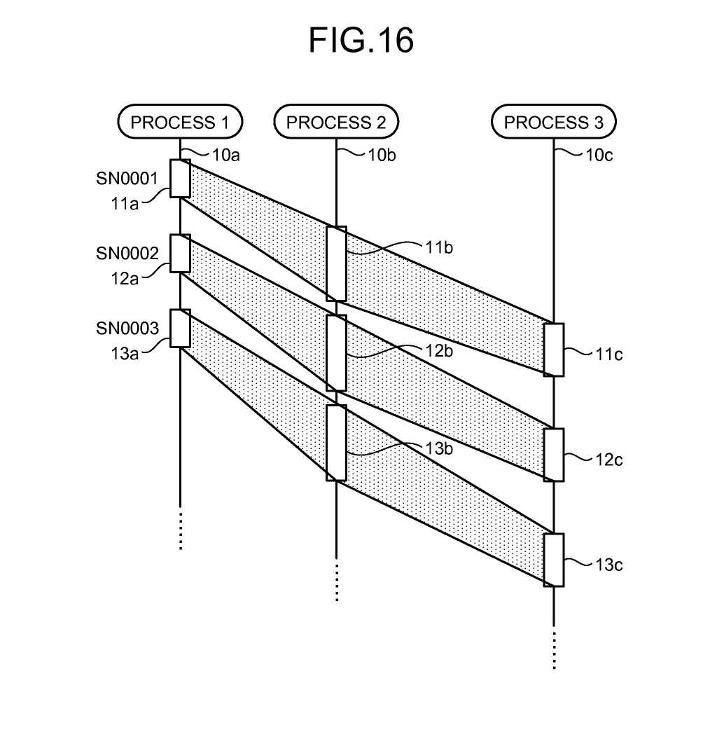

The following describes an example when the display device 100 adjusts the distances between the temporal axes with reference to FIG. 16. FIG. 16 is a schematic diagram to explain an example when the display device adjusts the distances between the temporal axes. For example, the output unit 113 of the display device 100 adjusts the width between the temporal axis 10a of the process 1 and the temporal axis 10b of the process 2, and the width between the temporal axis 10b of the process 2 and the temporal axis 10c of the process 3 in the following manner. The output unit 113 acquires the manufacturing starting time of the symbol 11a of the product “SN0001” when the manufacturing proceeds following the standard time in the process 1, and the manufacturing starting time of the symbol 11b of the product “SN0001” when the manufacturing proceeds following the standard time in the process 2. The output unit 113 calculates a difference value between the manufacturing starting time of the symbol 11b and the manufacturing starting time of the symbol 11c. The output unit 113 acquires the manufacturing starting time of the symbol 11c of the product “SN0001” when the manufacturing proceeds following the standard time in the process 3. The output unit 113 calculates a difference value between the manufacturing starting time of the symbol 11b and the manufacturing starting time of the symbol 11a. The output unit 113 adjusts the width between the temporal axes 10a and 10b, and the width between the temporal axes 10b and 10c based on a ratio of the difference value about the symbols 11b and 11a to the difference value about the symbols 11c and 11b.

For example, the output unit 113 adjusts the width between the temporal axes 10a and 10b and the width between the temporal axes 10b and 10c such that the ratio is three to five when the difference value about the symbols 11b and 11a is “0:15” and the difference value about the symbols 11c and 11b is “0:25”. The symbols 11a, 11b, and 11c indicate the manufacturing times in the corresponding respective processes when the processes 1 to 3 proceed following the respective standard times in an ideal manner.

Adjusting the distances between the temporal axes of the processes as described above, the output unit 113 outputs the upper sides of the zonal areas in the graph such that the upper sides become a straight line when the product is manufactured by following the respective standard times in the processes. For example, as the example illustrated in FIG. 16, the output unit 113 outputs the graph such that the upper sides of the zonal areas about the products “SN0001”, “SN0002”, and “SN0003” become a straight line. As a result, a screen can be produced that can visually detect a difference from the standard based on how the upper sides of the zonal areas deviate from the straight line. The placement unit 212 of the display device 200 may perform the processing described above and adjust the distances between the temporal axes of the apparatuses.

Extension of Band

The output unit 113 of the display device 100 may extend the upper side of the area beyond the last process and output the area in a visually recognizable color. The placement unit 212 of the display device 200 may form the band with the upper side being extended beyond the temporal axis of the last apparatus as the first band. The output unit 113 or the placement unit 212 may extend the upper sides of the zonal areas about the respective products beyond the temporal axis indicating the last process to form the bands or the zonal areas. The display device 100 may further display a line that connects the manufacturing starting times, which are the ones when the respective processes end following the respective standard times, of the respective processes. As a result, the display device 100 enables a manager to compare the line connecting the manufacturing starting times of the respective processes with the vertex of the extended band or zonal area, thereby making it possible to represent how much the manufacturing of the product is delayed to the manager.

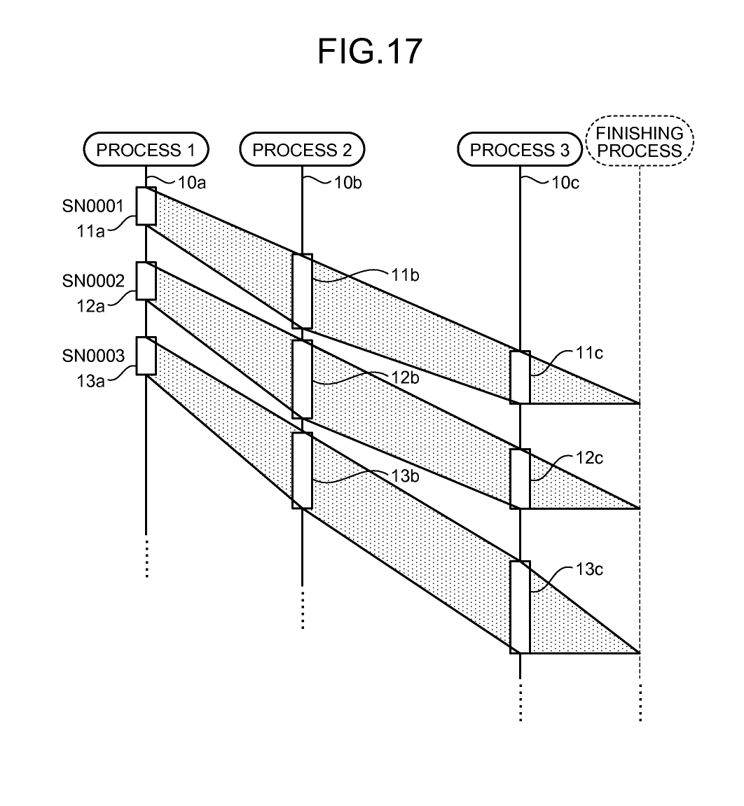

The following describes an example when the display device 100 extends the bands with reference to FIG. 17. FIG. 17 is a schematic diagram to explain an example when the display device extends the bands. As illustrated in the example of FIG. 17, the output unit 113 outputs the bands such that the upper sides of the zonal areas about the product “SN0001” become a straight line by adjusting the widths between the temporal axes of the processes using the technique described with reference to FIG. 16. The output unit 113 extends the upper side of the zonal area about the product “SN0001” beyond the process 3. A finishing process is virtually provided following the process 3. The distance between the temporal axes of the process 3 and the finishing process is determined by the technique of adjusting the widths between the temporal axes described with reference to FIG. 16 based on the time taken from the start to the end of the manufacturing in the process 3 when the production proceeds following the standard time in the process 3. The upper side of the zonal area is extended to a point where the line that extends perpendicular to the temporal axis 10c from the position indicating the manufacturing ending time of the symbol 11c of the process 3 intersects the temporal axis of the finishing process. The lower side of the zonal area is connected to the intersectional point. The output unit 113 then outputs the zonal areas including the area formed by being extended in a visually recognizable color. As a result of the extension of the upper side of the zonal area beyond the last process, a triangle area is formed on the right side of the last process. The output unit 113 extends the zonal area about the product “SN0002” and the zonal area about the product “SN0003”, and outputs the zonal areas in visually recognizable colors in the same manner as described above. The formation unit 213 of the display device 200 may perform the processing described above to extend the first bands.

For example, about the products “SN0001” and “SN0002”, the manufacturing of them proceed following the respective standard times from the process 1 to 3. Thus, the upper sides of their zonal areas from the process 1 to the finishing process are displayed as a straight line. In contrast, about the zonal areas of the product “SN0003”, the upper side of the zonal area deviates from the straight line at the process 3 because the width of the symbol 13c becomes larger due to the delay in the process 3. In this way, the output unit 113 can display the delay in the last process by extending the zonal area to the finishing process.

When the manufacturing in the last process proceeds following the standard time, the upper side extended beyond the last process is displayed as the straight line continuing from the upper side of the area of the last process. In contrast, when the manufacturing in the last process does not proceed following the standard time, the upper side extended beyond the last process deviates from the straight line at the last process. A manager can thus check whether the manufacturing in the last process is delayed by visually recognizing the extended zonal area as described above.

Display of Stripe Pattern as Background

The output unit 113 of the display device 100 or the formation unit 213 of the display device 200 may display a background for each product in the following manner. The background is the areas when the product is manufactured by the plurality of processes or the plurality of apparatuses by following the respective standard manufacturing times, or a stripe pattern that indicates a first stripe of a corresponding process. The output unit 113 or the formation unit 213 may display a stripe pattern that indicates the zonal areas when the respective processes proceed following the respective standard times on the background of the graph as another technique to check whether the respective processes proceed following the respective standard times.

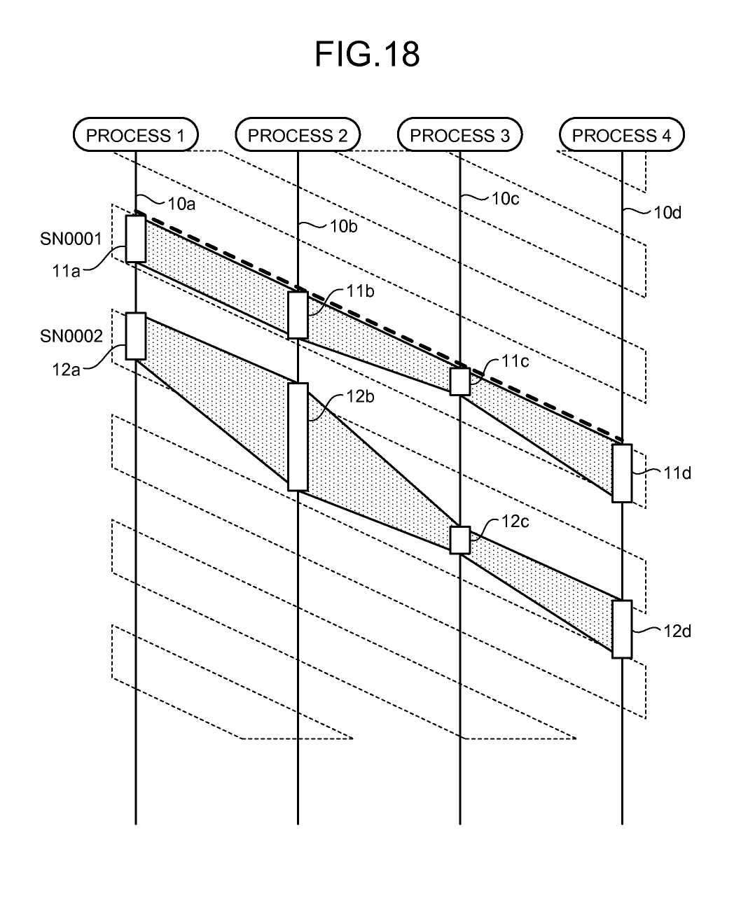

FIG. 18 is a schematic diagram to explain processing performed by the output unit when displaying the stripe background pattern on the graph. As illustrated in the example of FIG. 18, the output unit 113 of the display device 100 displays the stripe pattern indicated with the dotted lines on the background of the graph. The output unit 113 adjusts the positions and widths of the stripes of the pattern such that the zonal areas are within the stripes when the respective processes proceed following the respective standard times without any delay.

For example, about the product “SN0001”, the output unit 113 displays the graph in such a manner that the zonal areas are within the stripe of the pattern because the respective processes proceed following the respective standard times without any delay. In contrast, about the product “SN0002”, the output unit 113 displays the graph in such a manner that the symbol 12c of the process 3 and the symbol 12d of a process 4 are off the stripe of the pattern downward due to the delay in the process 2, for example. The display device 100 enables a manager to check a difference between the zonal area and the stripe of the pattern, thereby making it possible to display to the manager in which process the delay occurs in a recognizable manner. The formation unit 213 of the display device 200 may perform the processing described above to display the stripe background pattern.

Display of Event or Error

The display device 100 of the first embodiment or the display device 200 of the second embodiment may display, on each temporal axis, a pin that indicates an event or an error occurring in a corresponding process or apparatus.

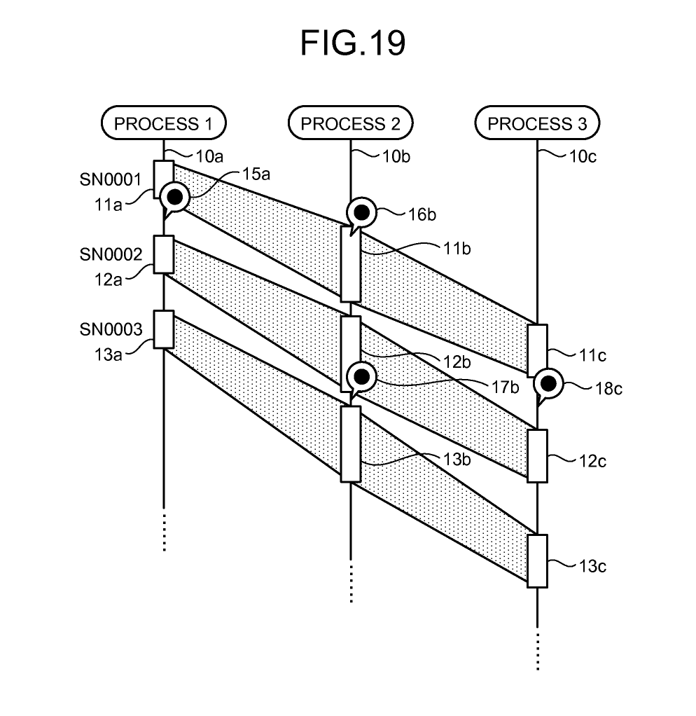

The following describes the processing performed by the placement unit when the pin, which indicates an event or an error occurring in a corresponding process, is displayed on each temporal axis. FIG. 19 is a schematic diagram illustrating an example of the processing performed by the placement unit when the pin, which indicates an event or an error occurring in a corresponding process, is displayed on each temporal axis. The history DB 121 includes the log information corresponding to the event or the error occurring in each process, for example. The placement unit 111 acquires the log information from the history DB 121. The placement unit 111 places a pin on the temporal axis of the corresponding process based on the date when the event or the error occurs, the date being included in the acquired log information. For example, the placement unit 111 places a pin 15a on the temporal axis 10a. The placement unit 111 places a pin 16b and a pin 17b on the temporal axis 10b. The placement unit 111 places a pin 18c on the temporal axis 10c. The output unit 113 outputs the graph to the display unit 101 in such a manner that the pins are placed on the graph. The resulting display makes it possible to check the log occurring just before the time it is determined that a problem may occur from the graph, thereby enhancing user-friendliness. The placement unit 111 may make it possible to check the log information when the pin is selected on the monitor. The placement unit 111 may place an image other than the pin on the graph.

The display device 200 according to the second embodiment may display the pins on the respective temporal axes. The identifying unit 211 acquires the logs the type of which is “error” from the log DB 221, for example. For example, the identifying unit 211 acquires the logs having the log numbers “4” and “8” the type of which is “error” when acquiring the log from the log DB 221 illustrated in FIG. 7. The identifying unit 211 places the pins on the respective temporal axes of the corresponding apparatuses based on the “date” included in the acquired logs. The formation unit 213 outputs the graph to the display unit 201 in such a manner that the pins are placed on the graph.

The display device 100 of the first embodiment or the display device 200 of the second embodiment may color the zonal areas or the first band about the product in which an error occurs in a different color than those of the others. This coloring makes it possible to readily identify the zonal areas or the first band about the product in which an error occurs even when a large number of zonal areas or the first bands are displayed in the graph.

Combination of a Plurality of Graphs

In the first embodiment, the zonal areas including the symbols indicating the manufacturing times and the waiting times are output in visually recognizable colors. In the second embodiment, the transition of the processing periods and the waiting periods is displayed as the stripes of different bands. The manner of display is not limited to those in the embodiments. The display device 100 may output a combination of graph areas that indicate the manufacturing times or the processing periods of the respective products and the graph areas that indicate the waiting times or the waiting periods of the respective products.

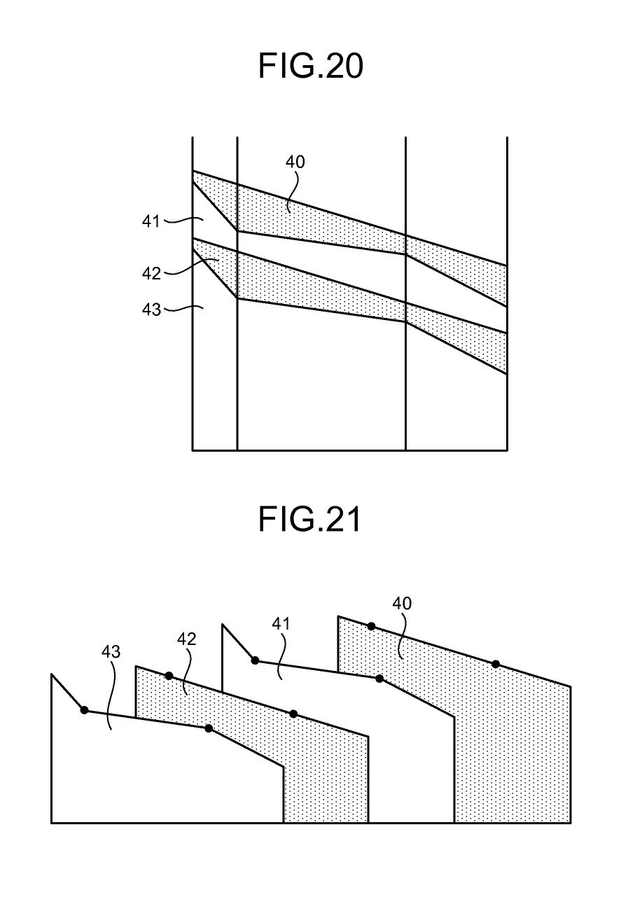

The following describes processing performed by the output unit when a plurality of graphs are combined with reference to FIGS. 20 and 21. FIG. 20 is a schematic diagram illustrating an example of a graph output by combining a plurality of graphs. FIG. 21 is a schematic diagram to explain the processing performed by the output unit that combines a plurality of graphs. As illustrated in the example of FIG. 21, the formation unit 112 forms a graph 40 that indicates the manufacturing starting times of a first manufacture (a first product), a graph 41 that indicates the manufacturing ending times of the first manufacture, a graph 42 that indicates the manufacturing starting times of a second manufacture (a second product), and a graph 43 that indicates the manufacturing ending times of the second manufacture. The formation unit 112 forms the graph indicating the manufacturing starting times and the graph indicating the manufacturing ending times for each product. The output unit 113 colors the graphs 40 and 42, which indicate the manufacturing starting times, in visually recognizable colors. The output unit 113 combines the graphs 40, 41, 42, and 43 and outputs the combined graph to the display unit 101. The output unit 113 outputs the graph, such as one illustrated in FIG. 20, for example. The display device 100 can output the graph in a short time depending on the form of the database that stores therein the manufacturing starting times and the manufacturing ending times. The display device 200 may perform the processing described above to display the graph by combining a plurality of graphs.

Other Examples of Display of Graph

In the first and the second embodiments, the zonal areas or the stripes of the bands are displayed in the graph. The manner of the display is not limited to those of the first and the second embodiments. The display device 100 or the display device 200 may display the manufacturing starting times and the manufacturing ending times using a single line. The display device 100 or 200 may display the manufacturing starting times and the manufacturing ending times using a single line by displaying the temporal axis indicating the manufacturing starting time and the temporal axis indicating the manufacturing ending time in parallel with each other in each step.

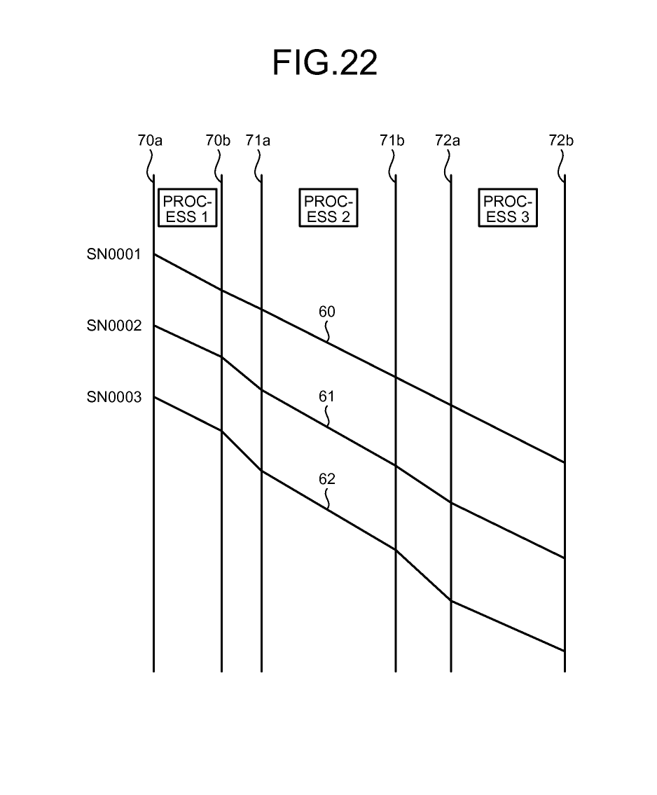

FIG. 22 is a schematic diagram illustrating an example of a graph when the manufacturing starting times and the manufacturing ending times are displayed using a single line. As illustrated in the example of FIG. 22, the display device 100 provides a temporal axis 70a that indicates the manufacturing starting time of the process 1 and a temporal axis 70b that indicates the manufacturing ending time of the process 1 in the graph. The display device 100 provides a temporal axis 71a that indicates the manufacturing starting time of the process 2 and a temporal axis 71b that indicates the manufacturing ending time of the process 2 in the graph. The display device 100 provides a temporal axis 72a that indicates the manufacturing starting time of the process 3 and a temporal axis 72b that indicates the manufacturing ending time of the process 3 in the graph.

The placement unit 111 places the respective manufacturing starting times about the products “SN0001”, “SN0002”, and “SN0003” on the temporal axis 70a indicating the manufacturing starting time of the process 1 based on the history DB 121. The placement unit 111 places the respective manufacturing ending times about the products “SN0001”, “SN0002”, and “SN0003” on the temporal axis 70b indicating the manufacturing ending time of the process 1 based on the history DB 121. The placement unit 111 places the respective manufacturing starting times about the products “SN0001”, “SN0002”, and “SN0003” on the temporal axis 71a indicating the manufacturing starting time of the process 2 based on the history DB 121. The placement unit 111 places the respective manufacturing ending times about the products “SN0001”, “SN0002”, and “SN0003” on the temporal axis 71b indicating the manufacturing ending time of the process 2 based on the history DB 121. The placement unit 111 places the manufacturing starting times and the manufacturing ending times about the process 3 in the same manner as described above.

The formation unit 112 forms a line 60 that connects the manufacturing starting times and the manufacturing ending times about the product “SN0001”, the times being placed by the placement unit 111. The formation unit 112 forms a line 61 that connects the manufacturing starting times and the manufacturing ending times about the product “SN0002”, the times being placed by the placement unit 111. The formation unit 112 forms a line 62 that connects the manufacturing starting times and the manufacturing ending times about the product “SN0003”, the times being placed by the placement unit 111. The output unit 113 outputs the lines 60, 61, and 62 formed by the formation unit 112 to the graph.

Management of the Number of Products in Process

The display device 100 according to the first embodiment or the display device 200 according to the second embodiment may count the number of areas or first bands that intersect a line extending perpendicular to the respective temporal axes, and when the number of areas or first bands is equal to or larger than a certain value, output information about the result of the counting. In other words, the display device 100 or 200 may manage the number of products in process using the formed graph.

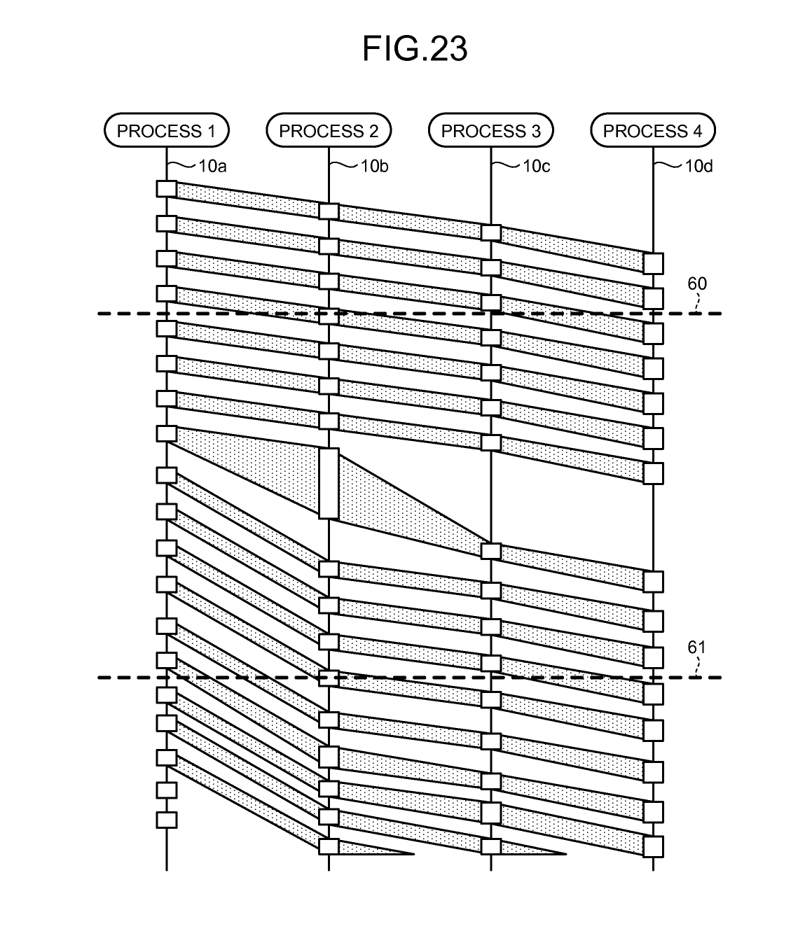

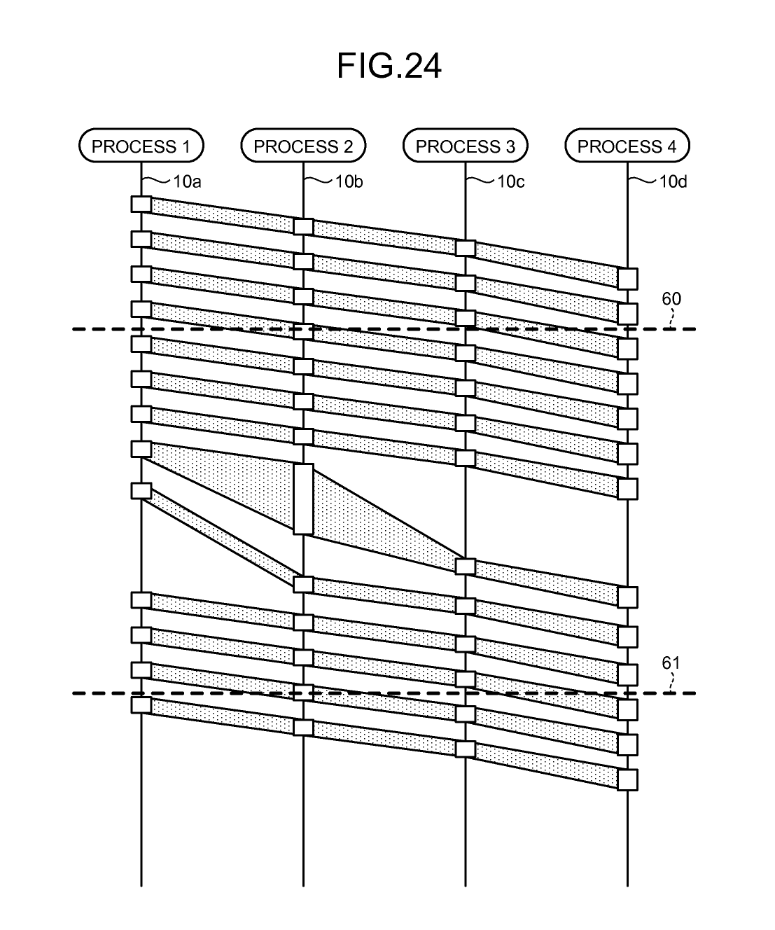

The following describes processing performed by the display device when managing the number of products in process with reference to FIGS. 23 and 24. FIG. 23 is a schematic diagram illustrating a first example to explain the processing performed by the display device when managing the number of products in process. As illustrated in the example of FIG. 23, the display device 100 displays a plurality of zonal areas in the graph. The display device 100 preliminarily sets a threshold of the standard number of products in process to “three”. The display device 100 provides a line perpendicular to the temporal axes 10a to 10d and scans the zonal areas along the line. For example, the display device 100 counts the number “two” of zonal areas intersecting the line 60. The display device 100 determines that the number of products in process is in the standard range because the number of products in process is two at this time.

The display device 100 further scans the zonal areas along another line provided perpendicular to the temporal axes 10a to 10d. For example, the display device 100 counts the number “four” of zonal areas intersecting the line 61. The display device 100 determines that an abnormality is found in the number of products in process because the number of products in process at this time is four, which is larger than that counted at the line 60, due to a delay in the process 2. In this case, the display device 100 outputs a warning of the abnormality in the number of products in process.

When outputting a warning, the display device 100 may display the warning in a window including the graph. The display device 100 may display a pop-up including the warning on the monitor. The display device 100 may transmit a mail including the warning to a manager. The display device 200 may perform the processing described above to manage the number of products in process.

The display device 100 or 200 may determine whether an earlier process starts after the completion of a later process in the factory based on the number of products in process. FIG. 24 is a schematic diagram illustrating a second example to explain the processing performed by the display device when managing the number of products in process. In the example of FIG. 23, the display device 100 determines that the earlier process starts before the later process is completed because the product is continuously manufactured with the same intervals even after the occurrence of a delay in the process 2 and thus the number of products in process at the time indicated by the line 61 is four, which is larger than that at the time indicated by the line 60. In the example of FIG. 24, the display device 100 determines that the earlier process starts after the later process is completed because the manufacturing of the product in the process 1 is purposely and temporarily stopped after the occurrence of a delay in the process 2 and thus the number of products in process at the time indicated by the line 61 is two, which is in the standard range. As a result, the display device 100 can determine whether what is called a just-in-time inventory management is observed between processes in the factory. The display device 200 may perform the processing described above to manage the number of products in process.

### Other Embodiments

In the first embodiment, the output unit 113 colors the zonal areas indicating the manufacturing times in certain colors. The manner of coloring is not limited to that in the first embodiment. For example, when an interim product manufactured in a certain process is a defective product, the output unit 113 may color the zonal area of the corresponding process in a different color from that of the other zonal areas of the product. When an interim product manufactured by a certain apparatus is a defective product, the placement unit 212 of the second embodiment may color the zonal area of the corresponding process in a different color from that of the other zonal areas of the product.

In the first embodiment, the output unit 113 colors the zonal areas indicating the manufacturing times in certain colors. The manner of coloring is not limited to that in the first embodiment. For example, when a different material is used in a certain process, the output unit 113 may color the corresponding zonal area in a different color from that in the other zonal areas of the product. When a different material is used in a certain process, the placement unit 212 of the second embodiment may color the zonal area of the corresponding process in a different color from that of the other zonal areas of the product.

The display device 100 or 200 may be a monitoring terminal that watches the whole of the processes or the apparatuses. The display device 100 or 200 may display the graph on the monitoring terminal through a network. The display device 100 or 200 may acquire the logs from the factory through a network and display a display content on a terminal in the factory or on a terminal of a manager through the network, for example.

In the second embodiment, the placement unit 212 places the symbols indicating the processing and the waiting periods, forms the first and the second bands, and displays the stripes of the bands on the display unit 201. The processing is not limited to that in the second embodiment. For example, a formation unit may form the first and the second bands based on the symbols indicating the processing and the waiting periods, which are placed by the placement unit 212, and display the stripes of the bands on the display unit 201.

In the third embodiment, the display device 100 of the first embodiment or the display device 200 of the second embodiment displays the pins that indicate events or errors occurring in processes or apparatuses on the corresponding respective temporal axes. The manner of display is not limited to that in the third embodiment. The display device 100 of the first embodiment or the display device 200 of the second embodiment may display images other than the pins.

In the third embodiment, the output unit 113 outputs the stripe pattern as the background pattern such that the zonal areas are within the stripes of the pattern when the respective processes proceed following the respective standard times without any delay. The manner of the output is not limited to that in the third embodiment. The output unit 113 may set the stripes of the pattern to be larger than the zonal areas formed when the respective processes proceed following the respective standard times.

The display device 100 of the first embodiment or the display device 200 of the second embodiment may display the band or the zonal area such that the upper side of the band or the zonal area has an angle between 40 to 50 degrees with 45 degrees as the center. As a result, when a delay occurs in a certain process or a certain apparatus, a change in angle of the upper side of the band or the zonal area is displayed as a large change. The display device 100 or 200 thus makes it possible for a manager to readily and visually recognize the delay in the process.

Hardware Structure of Display Terminal

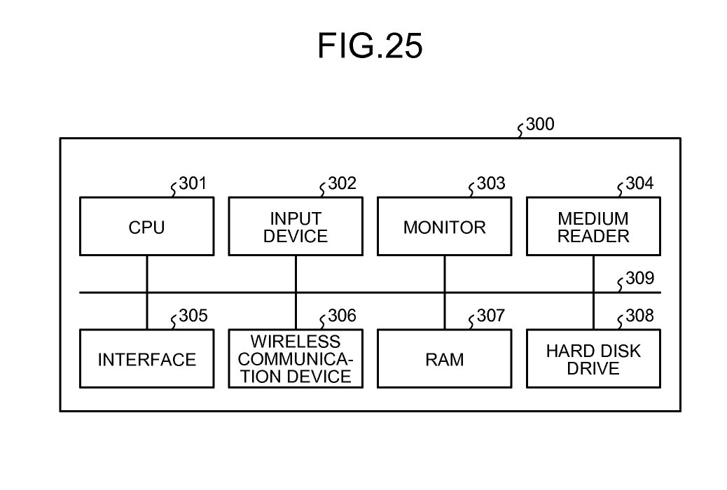

FIG. 25 is a schematic diagram illustrating a hardware structure of a computer used in the display device of the first or the second embodiment. As illustrated in FIG. 25, a computer 300 includes a CPU 301 that executes various types of arithmetic processing, an input device 302 that receives data input from a user, and a monitor 303. The computer 300 further includes a medium reader 304 that reads a program and the like from a storage medium, an interface 305 that connects the computer 300 to another device, and a wireless communication device 306 that wirelessly connects the computer 300 to another device. The computer 300 further includes a RAM 307 that temporarily stores therein various types of information and a hard disk drive 308. The respective components 301 to 308 are connected to a bus 309.

The hard disk drive 308 stores therein a display program that has the same functions as those of the placement unit 111, the formation unit 112, and the output unit 113 of the controller 110 illustrated in FIG. 1 and those of the identifying unit 211 and the placement unit 212 of the controller 210 illustrated in FIG. 7. The hard disk drive 308 stores therein various types of data used for achieving the display program.

The CPU 301 reads programs stored in the hard disk drive 308, loads the programs to the RAM 307, and executes them, thereby performing various types of processing. The programs can cause the computer 300 to function as the placement unit 111, the formation unit 112, and the output unit 113 of the controller 110 illustrated in FIG. 1 and the identifying unit 211 and the placement unit 212 of the controller 210 illustrated in FIG. 7.

A display program described above is not always requested to be stored in the hard disk drive 308. For example, the computer 300 may read the program stored in a storage medium readable by the computer 300 and execute the read program. Examples of the storage medium readable by the computer 300 include a portable recording medium such as a compact disc (CD)-ROM, a digital versatile disc (DVD), or a universal serial bus (USB) memory, a semiconductor memory such as a flash memory, and a hard disk drive. The program may be stored in a device connected to a public line, the Internet, or a local area network (LAN), for example, and the computer 300 may read the program from the device and execute the read program.

The invention can provide an advantage of displaying the manufacturing time and the waiting time of each process in a visually recognizable manner.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A visualization method of manufacturing status, the visualization method being implemented by a computer that visualizes manufacturing status of a product manufactured sequentially by a plurality of processes, the visualization method comprising:
placing a first symbol that indicates a start and an end of the manufacturing of the product in a first process of the processes on a first temporal axis of the first process with a width corresponding to a time taken from the start to the end of the manufacturing in the first process, and a second symbol that indicates a start and an end of the manufacturing of the product in a second process following the first process on a second temporal axis of the second process with a width corresponding to a time taken from the start to the end of the manufacturing in the second process, the first and the second temporal axes extending in a same direction, using a processor;
forming a first line that connects a part indicating the start of the manufacturing in the first symbol placed on the first temporal axis of the first process and a part indicating the start of the manufacturing in the second symbol placed on the second temporal axis of the second process, and a second line that connects another part indicating the end of the manufacturing in the first symbol and another part indicating the end of the manufacturing in the second symbol, using the processor;
outputting lines indicating the first and the second temporal axes, the first symbol, and the second symbol, using the processor; and
outputting an area defined by the first symbol, the first line, the second symbol, and the second line in a visually recognizable color, using the processor.

2. A display method of manufacturing status, the display method being implemented using a computer, the display method comprising:
identifying a processing period and a waiting period of a first apparatus included in a manufacturing line and a processing period and a waiting period of a second apparatus included in the manufacturing line and performing processing after processing in the first apparatus, based on log information about the processing in the first apparatus and log information about the processing in the second apparatus, using a processor;
placing the identified processing period and waiting period of the first apparatus on a first temporal axis that indicates a change in processing and waiting periods of the first apparatus, and the identified processing period and waiting period of the second apparatus on a second temporal axis that is in parallel with the first temporal axis and indicates a change in processing and waiting periods of the second apparatus, using the processor;
forming a first band that connects the processing periods of a manufacturing product common between the first apparatus and the second apparatus, and a second band that connects the waiting periods of the manufacturing product common between the first apparatus and the second apparatus, each of the waiting periods following the processing of the manufacturing product, using the processor; and
displaying transition of the processing periods and the waiting periods as stripes of different bands, using the processor.

3. The visualization method of manufacturing status according to claim 1, wherein, when the manufacturing of the product proceeds following respective standard manufacturing times of the processes or apparatuses, distances between the temporal axes are adjusted such that upper sides of areas or first bands become a straight line at the outputting the area or displaying transition, using the processor.

4. The visualization method of manufacturing status according to claim 3, wherein
at the outputting the area, the area with an extended upper side is output in a visually recognizable color, the upper side is extended such that a line that is perpendicular to a temporal axis of a last process and extended from the part indicating the end of the manufacturing in the last process intersects another temporal axis provided next to the temporal axis of the last process, the distance between the temporal axis of the last process and the other temporal axis being set based on the standard manufacturing time of the last process, using the processor, or
at the displaying the transition, the first band with an extended upper side is formed, the upper side is extended such that a line that is perpendicular to a temporal axis of a last apparatus and extended from the part indicating the end of the processing period of the last apparatus intersects another temporal axis provided next to the temporal axis of the last apparatus, the distance between the temporal axis of the last apparatus and the other temporal axis being set based on the standard manufacturing time of the last apparatus, using the processor.

5. The visualization method of manufacturing status according to claim 1, wherein, at the outputting the area or displaying transition, a stripe pattern is further displayed on a background for each product, the stripe pattern indicating a first stripe in each process or the areas when the manufacturing of the product proceeds following respective standard manufacturing times of the processes or apparatuses, using the processor.

6. The visualization method of manufacturing status according to claim 1, wherein, at the outputting the area or displaying transition, an image that indicates an event or an error occurring in a process or an apparatus is further displayed on the corresponding temporal axis, using the processor.

7. The visualization method of manufacturing status according to claim 1, wherein, at the outputting the area or displaying transition, the area or a first band is further displayed in different colors depending on types of the product, using the processor.

8. The visualization method of manufacturing status according to claim 1, further including:
counting number of areas or first bands that intersect a line extending perpendicular to each temporal axis, using the processor; and
outputting information of the number of areas or first bands being equal to or larger than a certain value when the number of areas or first bands is equal to or larger than the certain value, using the processor.

9. A display device comprising:
a memory; and
a processor coupled to the memory, wherein the processor configured
to place a first symbol that indicates a start and an end of manufacturing of a product in a first process of a plurality of processes on a first temporal axis of the first process with a width corresponding to a time taken from the start to the end of the manufacturing in the first process, and a second symbol that indicates a start and an end of the manufacturing of the product in a second process following the first process on a second temporal axis of the second process with a width corresponding to a time taken from the start to the end of the manufacturing in the second process, the first and the second temporal axes extending in a same direction,
to form a first line that connects a part indicating the start of the manufacturing in the first symbol placed on the first temporal axis of the first process and a part indicating the start of the manufacturing in the second symbol placed on the second temporal axis of the second process, and a second line that connects another part indicating the end of the manufacturing in the first symbol and another part indicating the end of the manufacturing in the second symbol, and
to output lines indicating the first and the second temporal axes, the first symbol, and the second symbol, and outputs an area defined by the first symbol, the first line, the second symbol, and the second line in a visually recognizable color.

10. A non-transitory computer-readable recording medium having stored therein a program that causes a computer that visualizes manufacturing status of a product manufactured sequentially by a plurality of processes to execute a display process of manufacturing status comprising:
placing a first symbol that indicates a start and an end of the manufacturing of the product in a first process of the processes on a first temporal axis of the first process with a width corresponding to a time taken from the start to the end of the manufacturing in the first process, and a second symbol that indicates a start and an end of the manufacturing of the product in a second process following the first process on a second temporal axis of the second process with a width corresponding to a time taken from the start to the end of the manufacturing in the second process, the first and the second temporal axes extending in a same direction;
forming a first line that connects a part indicating the start of the manufacturing in the first symbol placed on the first temporal axis of the first process and a part indicating the start of the manufacturing in the second symbol placed on the second temporal axis of the second process, and a second line that connects another part indicating the end of the manufacturing in the first symbol and another part indicating the end of the manufacturing in the second symbol;
outputting lines indicating the first and the second temporal axes, the first symbol, and the second symbol; and
outputting an area defined by the first symbol, the first line, the second symbol, and the second line in a visually recognizable color.
